(19) United States
(12) Patent Application Publication
(10) Pub. No.: US 2014/0372892 A1
(43) Pub. Date: Dec. 18, 2014

(54) ON-DEMAND INTERFACE REGISTRATION WITH A VOICE CONTROL SYSTEM

(71) Applicant: MICROSOFT CORPORATION, Redmond, WA (US)

(72) Inventors: GERSHOM LOUIS PAYZER, REDMOND, WA (US); NICHOLAS DORIAN RAPP, SEATTLE, WA (US); NALIN SINGAL, BELLEVUE, WA (US); LAWRENCE WAYNE OLSON, ISSAQUAH, WA (US)

(21) Appl. No.: 13/920,905

(22) Filed: Jun. 18, 2013

(51) Int. Cl. G06F 3/16

(52) U.S. Cl. CPC G06F 3/167
USPC 715/728

(57) ABSTRACT

Embodiments of the present invention automatically register user interfaces with a voice control system. Registering the interface allows interactive elements within the interface to be controlled by a user's voice. A voice control system analyzes audio including voice commands spoken by a user and manipulates the user interface in response. The automatic registration of a user interface with a voice control system allows a user interface to be voice controlled without the developer of the application associated with the interface having to do anything. Embodiments of the invention allow an application's interface to be voice controlled without the application needing to account for states of the voice control system.

### BACKGROUND

Voice as an input mechanism is becoming more popular every day. Many smartphones, televisions, game consoles, tablets, and other devices provide voice input. Voice input is provided on the Web via a new W3C standard and is in a number of browsers. But application developers struggle to use the APIs exposed by these voice systems. Currently, voice commands are added to and removed from a voice control system following a series of unintuitive rules.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention automatically register user interfaces with a voice control system. Registering the interface allows interactive elements within the interface to be controlled by a user's voice. A voice control system analyzes audio including voice commands spoken by a user and manipulates the user interface in response. The user may select a button on a user interface by speaking a voice phrase associated with that control element. For example, the user might say “play” to select the play button in a media control interface.

The automatic registration of a user interface with a voice control system allows a user interface to be voice controlled without the developer of the application associated with the interface having to do anything. For example, the developer does not need to write code for the application to control the voice control system. Embodiments of the invention allow an application's interface to be voice controlled without the application needing to account for states of the voice control system.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of a computing environment suitable for voice control interfaces, in accordance with an embodiment of the present invention;

FIG. 3 is a flow chart showing a method of enabling a voice control system to control a user interface, in accordance with an embodiment of the present invention;

FIG. 4 is a diagram showing a user interface with elements suitable for voice control, in accordance with an embodiment of the present invention;

FIG. 5 is a diagram showing a user interface with elements suitable for voice control that have been annotated with voice phrases, in accordance with an embodiment of the present invention;

FIG. 6 is a diagram showing a user interface with enumerable elements suitable for voice control, in accordance with an embodiment of the present invention; and

FIG. 7 is a diagram showing a user interface with enumerable elements suitable for voice control that have been annotated with voice phrases, in accordance with an embodiment of the present invention;

FIG. 8 is a flow chart showing a method of automatically enabling a voice control system to control an element within a user interface, in accordance with an embodiment of the present invention; and

FIG. 9 is a flow chart showing a method of automatically enabling a voice control system to control an element within a user interface, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention automatically register user interfaces with a voice control system. Registering the interface allows interactive elements within the interface to be controlled by a user's voice. A voice control system analyzes audio including voice commands spoken by a user and manipulates the user interface in response. The user may select a button on a user interface by speaking a voice phrase associated with that control element. For example, the user might say “play” to select the play button in a media control interface.

The automatic registration of a user interface with a voice control system allows a user interface to be voice controlled without the developer of the application associated with the interface having to do anything. For example, the developer does not need to write code for the application to control the voice control system. Embodiments of the invention allow an application's interface to be voice controlled without the application needing to account for states of the voice control system.

In one embodiment, while not necessary, developers are able to annotate control elements within a user interface with metadata that is used by the automatic registration system to specify aspects of the voice control. For example, a specific voice phrase used to control an element may be associated with the element. In addition, a voice instruction that communicates to the user what to say to select the interactive element may be specified in meta data.

Embodiments of the present invention, may register each interactive element in an interface that is suitable for voice control with the voice control system. Registering an element with the voice control system includes associating the element with the voice phrase that controls the element within the voice control system.

Once registered, the voice control system listens for a voice phrase. Once a voice phrase associated with a control element is recognized, then a callback handler associated with the element is invoked. For example, a click handler may be invoked for a button selected by clicking. Once the user interface changes, the active listening mode may be automatically shut down and any mapped elements and voice phrases cleared from the voice control system. The process may repeat as new interfaces become active or an active application is updated. When the active listening process is done resources in the voice control system are released. Releasing the resources may include deleting entries made in the voice control system's memory.

Having briefly described an overview of embodiments of the invention, an exemplary operating environment suitable for use in implementing embodiments of the invention is described below.

### Exemplary Operating Environment

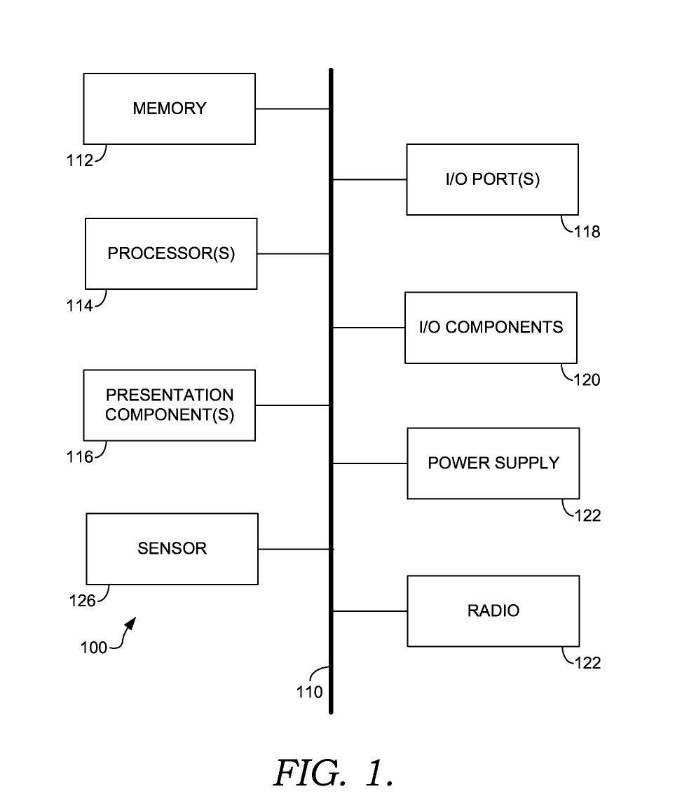

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a person or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Advertising and Content Service

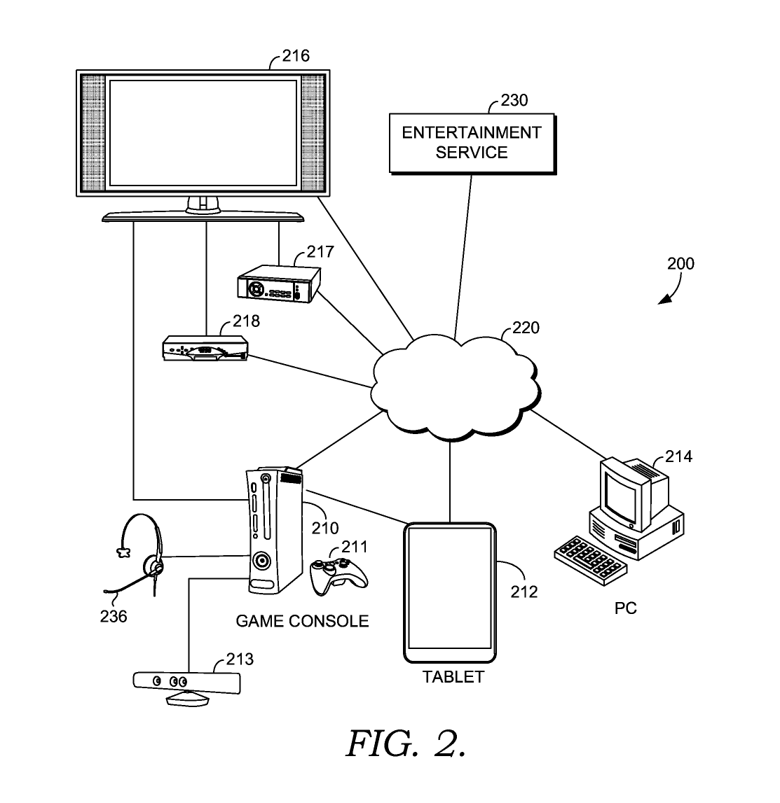

Turning now to FIG. 2, an entertainment environment 200 where voice control may be used is shown, in accordance with an embodiment of the present invention. Embodiments of the invention are not limited to entertainment embodiments, but many entertainment devices may generate interfaces that are suitable for voice control. The online entertainment environment 200 comprises various entertainment devices connected through a network 220 to an entertainment service 230. Exemplary entertainment devices include a game console 210, a tablet 212, a personal computer 214, a digital video recorder 217, a cable box 218, and a television 216. Use of other entertainment devices not depicted in FIG. 2, such as smart phones, is also possible.

The game console 210 may have one or more game controllers communicatively coupled to it. In one embodiment, the tablet 212 may act as an input device for the game console 210 or the personal computer 214. In another embodiment, the tablet 212 is a stand-alone entertainment device. Network 220 may be a wide area network, such as the Internet. As can be seen, most devices shown in FIG. 2 could be directly connected to the network 220. The devices shown in FIG. 2, are able to communicate with each other through the network 220 and/or directly as indicated by the lines connecting the devices.

The controllers associated with game console 210 include a game pad 211, a headset 236, an imaging device 213, and a tablet 212. The headset 236 may be used to receive voice commands as may microphones associated with any of the controllers or devices shown in FIG. 2. Tablet 212 is shown coupled directly to the game console 210, but the connection could be indirect through the Internet or a subnet. In one embodiment, the entertainment service 230 helps make a connection between the tablet 212 and the game console 210. The tablet 212 is capable of generating numerous input streams and may also serve as a display output mechanism. In addition to being a primary display, the tablet 212 could provide supplemental information related to primary information shown on a primary display, such as television 216. The input streams generated by the tablet 212 include video and picture data, audio data, movement data, touch screen data, and keyboard input data.

The headset 236 captures audio input from a player and the player's surroundings and may also act as an output device, if it is coupled with a headphone or other speaker. The headset 236 may communicate an audio stream including voice commands to one or more devices shown in FIG. 2, including remote devices such entertainment service 230.

The imaging device 213 is coupled to game console 210. The imaging device 213 may be a video camera, a still camera, a depth camera, or a video camera capable of taking still or streaming images. In one embodiment, the imaging device 213 includes an infrared light and an infrared camera. The imaging device 213 may also include a microphone, speaker, and other sensors. In one embodiment, the imaging device 213 is a depth camera that generates three-dimensional image data. The three-dimensional image data may be a point cloud or depth cloud. The three-dimensional image data may associate individual pixels with both depth data and color data. For example, a pixel within the depth cloud may include red, green, and blue color data, and X, Y, and Z coordinates. Stereoscopic depth cameras are also possible. The imaging device 213 may have several image-gathering components. For example, the imaging device 213 may have multiple cameras. In other embodiments, the imaging device 213 may have multidirectional functionality. In this way, the imaging device 213 may be able to expand or narrow a viewing range or shift its viewing range from side to side and up and down.

The game console 210 may have image-processing functionality that is capable of identifying objects within the depth cloud. For example, individual people may be identified along with characteristics of the individual people. In one embodiment, gestures made by the individual people may be distinguished and used to control games or media output by the game console 210. The game console 210 may use the image data, including depth cloud data, for facial recognition purposes to specifically identify individuals within an audience area. The facial recognition function may associate individuals with an account associated with a gaming service or media service, or used for login security purposes, to specifically identify the individual.

In one embodiment, the game console 210 uses microphone, and/or image data captured through imaging device 213 to identify content being displayed through television 216. For example, a microphone may pick up the audio data of a movie being generated by the cable box 218 and displayed on television 216. The audio data may be compared with a database of known audio data and the data identified using automatic content recognition techniques, for example. Content being displayed through the tablet 212 or the PC 214 may be identified in a similar manner. In this way, the game console 210 is able to determine what is presently being displayed to a person regardless of whether the game console 210 is the device generating and/or distributing the content for display.

The game console 210 may include classification programs that analyze image data to generate audience data. For example, the game console 210 may determine number of people in the audience, audience member characteristics, levels of engagement, and audience response.

In another embodiment, the game console 210 includes a local storage component. The local storage component may store user profiles for individual persons or groups of persons viewing and/or reacting to media content. Each user profile may be stored as a separate file, such as a cookie. The information stored in the user profiles may be updated automatically. Personal information, viewing histories, viewing selections, personal preferences, the number of times a person has viewed known media content, the portions of known media content the person has viewed, a person's responses to known media content, and a person's engagement levels in known media content may be stored in a user profile associated with a person. As described elsewhere, the person may be first identified before information is stored in a user profile associated with the person. In other embodiments, a person's characteristics may be first recognized and mapped to an existing user profile for a person with similar or the same characteristics. Demographic information may also be stored. Each item of information may be stored as a “viewing record” associated with a particular type of media content. As well, viewer personas, as described below, may be stored in a user profile.

Entertainment service 230 may comprise multiple computing devices communicatively coupled to each other. In one embodiment, the entertainment service is implemented using one or more server farms. The server farms may be spread out across various geographic regions including cities throughout the world. In this scenario, the entertainment devices may connect to the closest server farms. Embodiments of the present invention are not limited to this setup. The entertainment service 230 may provide primary content and secondary content. Primary content may include television shows, movies, and video games. Secondary content may include advertisements, social content, directors' information and the like.

FIG. 2 also includes a cable box 218 and a DVR 217. Both of these devices are capable of receiving content through network 220. The content may be on-demand or broadcast as through a cable distribution network. Both the cable box 218 and DVR 217 have a direct connection with television 216. Both devices are capable of outputting content to the television 216 without passing through game console 210. As can be seen, game console 210 also has a direct connection to television 216. Television 216 may be a smart television that is capable of receiving entertainment content directly from entertainment service 230. As mentioned, the game console 210 may perform audio analysis to determine what media title is being output by the television 216 when the title originates with the cable box 218, DVR 217, or television 216.

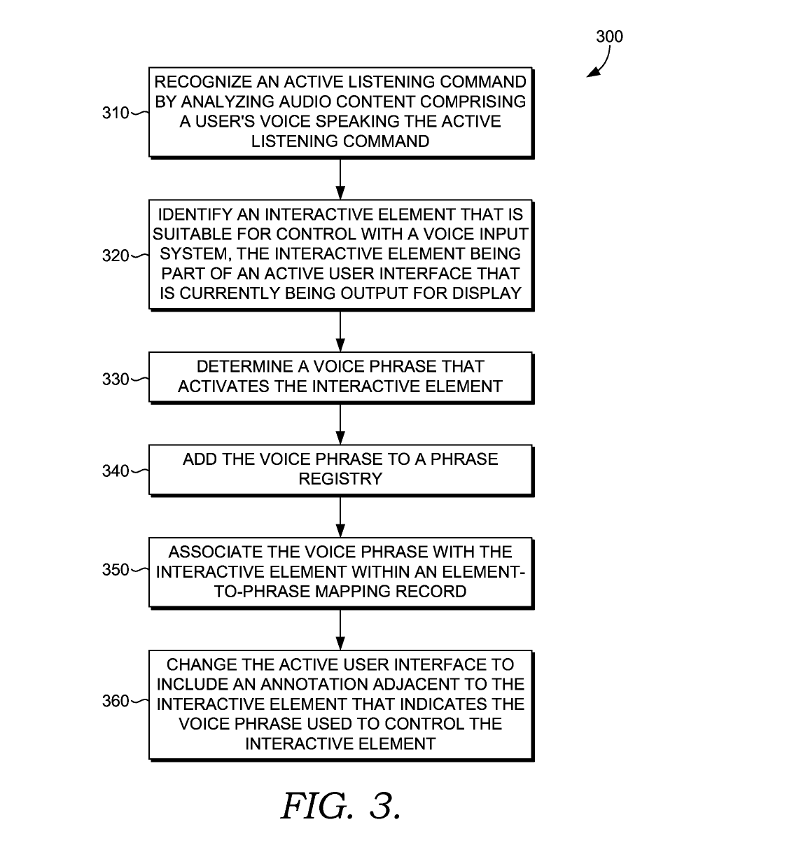

Turning now to FIG. 3, a method 300 of enabling a voice control system to control a user interface is shown, in accordance with an embodiment of the present invention. Method 300 may be performed on a computing device similar to computing device 100 described previously. Method 300 may also be performed in a distributed computing environment. For example, the voice control system may reside in a data center that is remotely connected to a computing device outputting a user interface. The voice data or recording may be communicated to the voice control system for analysts. The registration system may operate on a local client or in a data center. Similarly, the application creating the interface may reside in a data center or remote server, while the registration process and voice control system reside on the client. Other combinations of arrangements are possible. In one embodiment, the voice control system and registration system form a single component. In another embodiment, the registration system is a bridge between applications and the voice control system.

At step 310, an active listening command is recognized by analyzing audio content comprising a user's voice speaking the active listening command. The audio content may be generated by a microphone communicatively coupled to the computing device. The connection may be wired or wireless. An active listening command is a command a user speaks when he wishes to use a voice control system. In one embodiment, the voice control command is not a commonly spoken word and the voice control system is passively listening for that word. The registration system may work in conjunction with the voice control system to detect a word or phrase of interest. For example, upon detecting the active listening command, the voice control system may notify an interface registration system.

The voice control system is activated in response to the active listening command. In real time, the active interface is analyzed. A snapshot of the interface that includes relevant interface features may be created and analyzed. The interface may be analyzed in different ways. In one embodiment, the code within a user interface framework is analyzed to determine interactive elements within the interface that may be voice controlled. For example, buttons within the interface are interactive elements that may be voice controlled in certain circumstances. Interface elements that may be clicked, hovered on or otherwise selected may be considered interactive elements. The interactive elements may take the form of a picture, graphic, button, or other control element. Hyperlinked text may be considered an interactive element. In one embodiment, unlinked text, images, and background are not considered interactive.

At step 320, an interactive element that is suitable for control with a voice input system is identified. The interactive element is part of an active user interface that is currently being output for display. The active user interface is the interface with which a user is presently interacting. Interacting may take multiple forms. In one example, the topmost application window is deemed to be the active interface. In another embodiment, the user interface most recently receiving user interactions is deemed the active user interface. In another embodiment, the most recently opened user interface is deemed the active user interface.

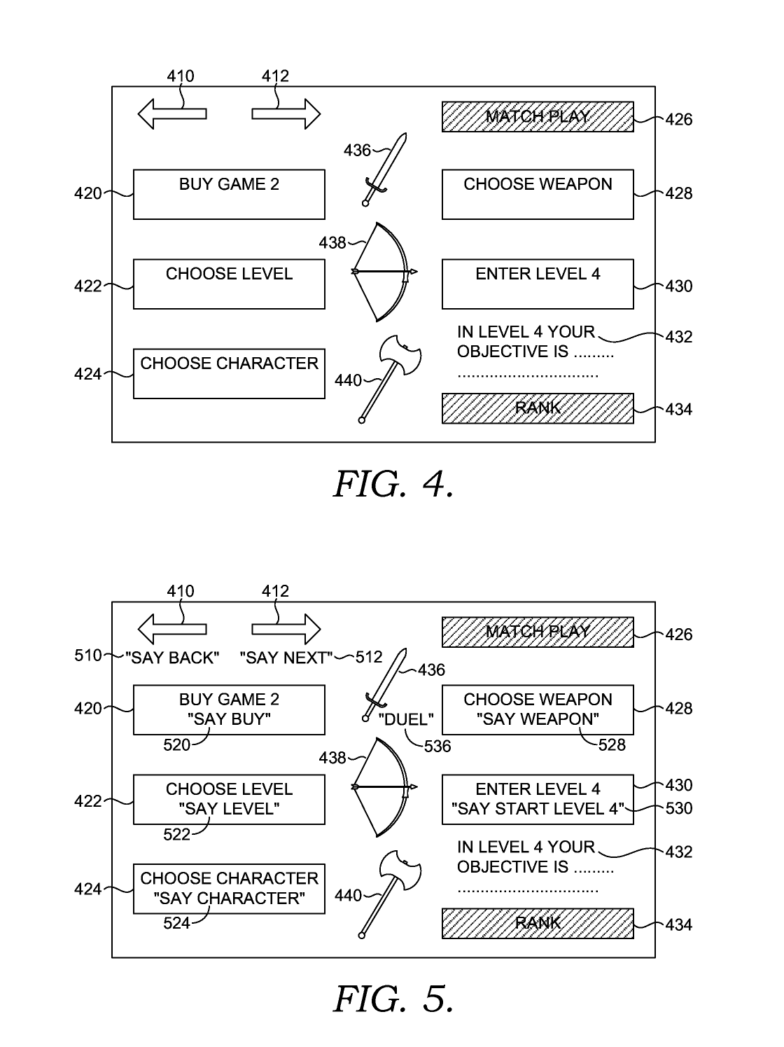

Turning briefly to FIG. 4, an exemplary active user interface suitable for registration with a voice control system is shown, in accordance with an embodiment of the present invention. Interface 400 includes a back arrow 410 and a forward arrow 412. Selection of back arrow 410 navigates the interface to a previous user interface while the forward arrow 412 navigates the interface to the subsequent interface in a sequence of interfaces. At any given time, either the back arrow 410 or the forward arrow 412 may be interactive. If there is not a user interface to go back to or navigate forward to, then one or both arrows may be grayed out or otherwise indicated as deactivated. Deactivated or disabled interface features may be considered unsuitable for voice control.

Interface 400 includes several selectable tiles. Tile 420 allows the user to buy game 2. Selecting tile 420 may open a new interface through which the user is able to confirm the purchase of game 2. Tile 422 allows the user to choose a level within the game application that is associated with interface 400. The tile 424 allows the user to choose a game character. Selecting the choose character tile 424 or the choose level tile 422 may open different interfaces. The entry-level 4 tile 430 will drop the user directly into level 4 of the game experience. The choose weapon tile 428 allows the user to choose a weapon within a newly opened interface.

The matchplay tile 426 and the rank tile 434 are disabled and shown as grayed out. As mentioned, a disabled element is not presently able to be selected, and thus not suitable for voice control. The text 432 is also not interactive and thus not suitable for voice control in some embodiments. In other embodiments, the text may be selectable for the purpose of copying.

The sword graphic 436, bow graphic 438, and the axe graphic 440 represent user interface elements. In this example, only the sword graphic 436 is interactive.

As mentioned previously, in step 320, elements that are suitable for control with a voice input system are identified. Within user interface 400, the interactive elements include back arrow 410, forward arrow 412, tile 420, tile 422, tile 424, tile 428, tile 430, and sword graphic 436. The remaining elements are not presently interactive and are not considered suitable for voice control. In addition to disabled status, any interface elements appearing outside of the rendered user interface may be excluded from consideration as a suitable control element. Any elements that are hidden within the interface may also be excluded from selection as a suitable interactive element.

Returning now to FIG. 3, at step 330, a voice phrase that activates the interactive element is determined. The voice phrase may comprise a single word or multiple words. In one embodiment, the voice phrase is taken from text within the title or displayed text of the interactive element. For example the text in tile 420 says “buy game 2.” The voice phrase associated with tile 420 may be the word “buy.” In one embodiment, multiple voice phrases may be associated with a control element. As explained in more detail subsequently, the voice phrase may be specified by the application using meta data associated with the control element.

At step 340, the voice phrase is added to a phrase registry. The phrase registry is a data store adapted to store phrases the voice control system attempts to identify. The phrase registry may be part of the voice control system. The phrase registry lists words for which the voice control system actively listens. Upon detecting a word within the phrase registry, the voice control system may check an element-to-phrase mapping record to determine what action is taken in response.

At step 350, the voice phrase is associated with the interactive element within the element-to-phrase mapping record. This record records associations between the element and the voice phrase. In addition, a control action or callback function may also be associated with the element within the element-to-phrase mapping record.

At step 360, the active user interface is changed to include an annotation adjacent to the interactive element that communicates the voice phrase used to control the interactive element. This provides instruction to the user that allows the user to know what to say to select or interact with an element in the user interface.

When the active listening process is done resources in the voice control system are released. The active listening process may end when a voice control instruction is received and the interface updated. In one embodiment, the active listening process times out after a threshold amount of time passes. Releasing the resources may include deleting entries made in the voice control system's memory. Releasing the resources frees the voice control system to control a new active interface.

Turning now to FIG. 5, exemplary annotations are illustrated in accordance with an embodiment of the present invention. The annotation “say back” 510 is associated with back arrow 410. The annotation “say next” 512 is associated with forward arrow 412. The back arrow 410 and the forward arrow 412 do not include displayed text. The words “back” and “next” may be taken from titles of the interface elements. In another embodiment, the text is taken from metadata within or associated with the interface element that designates the voice phrase.

The annotation “say buy” 520 is associated with tile 420. The annotation “say level” 522 is associated with tile 422. The annotation “say character” 524 is associated with tile 424. The annotation “say weapon” 528 is associated with tile 428. The annotation “say start level 4” 530 is associated with tile 430. Notice that all of these annotations are formed by combining the element's voice phrase with the word “say.” Also, all of the phrases are based on text taken from the title of the button with a few exceptions.

Tile 430 includes text that is slightly different from text in the tile. The text says “enter level 4,” while the annotation says “start level 4.” This illustrates that the text displayed on the control element may be different from text used for the voice phrase. The voice phrase “start level 4” may have been specified in metadata for tile 430.

The sword graphic 436 is associated with the voice phrase “dual.” Notice that the annotation “dual” 536 does not include the “say” instruction. Whether or not to include the say instruction may be specified in metadata instructions associated with interface elements. In another embodiment, the registration system may leave out the say instruction or equivalent based on space constraints or other preferences. In one embodiment, the voice phrases are all included in text boxes that are located adjacent to the interactive element.

In one embodiment, developers or other entities may specify where and how an annotation is provided. For example a font, text color, size and other characteristics could be specified within metadata associated with each element. In another embodiment, aspects of the annotation are stored with the user interface and applied to all of the interactive elements within the user interface without being included in metadata associated with each element. Alternatively, the characteristics of the annotation may be specified on a per-element basis. In one embodiment, a graphic may be used as the annotation and associated with each interactive element.

Once the interface is annotated and actively listening for voice phrases, and a voice phrase is detected, then a callback function associated with the element is retrieved and the proper action taken. At this point, the voice phrases in the phrase registry and the voice phrase and interactive element association within the element-to-phrase mapping record may be deleted. The registration process may begin again with the next interface that appears in response to the previous action. The new interface is the new active interface.

In one embodiment, the interface is evaluated for changes at regular intervals. For example, an active interface is evaluated for changes every five seconds to see whether an element has been added, deleted, or changed in status from active to disabled. For example, a previously interactive element may become active based on a change of context. A stop button may be deactivated upon the media presentation concluding. The play button may be simultaneously activated. In this example, the play button would be registered and the stop button deregistered from the system.

Registering the play button may require deleting all of the elements and adding all of the active elements, including the play button, to the phrase registry and element-to-phrase mapping record. Alternatively, the play button is simply added to the existing active elements within the element-to-phrase mapping record and phrase registry. In order to add the play element to the element-to-phrase mapping record, a voice phrase is detected according to the procedures described previously. Similarly, a single element may be removed in isolation or all elements removed and re-added without the disabled element.

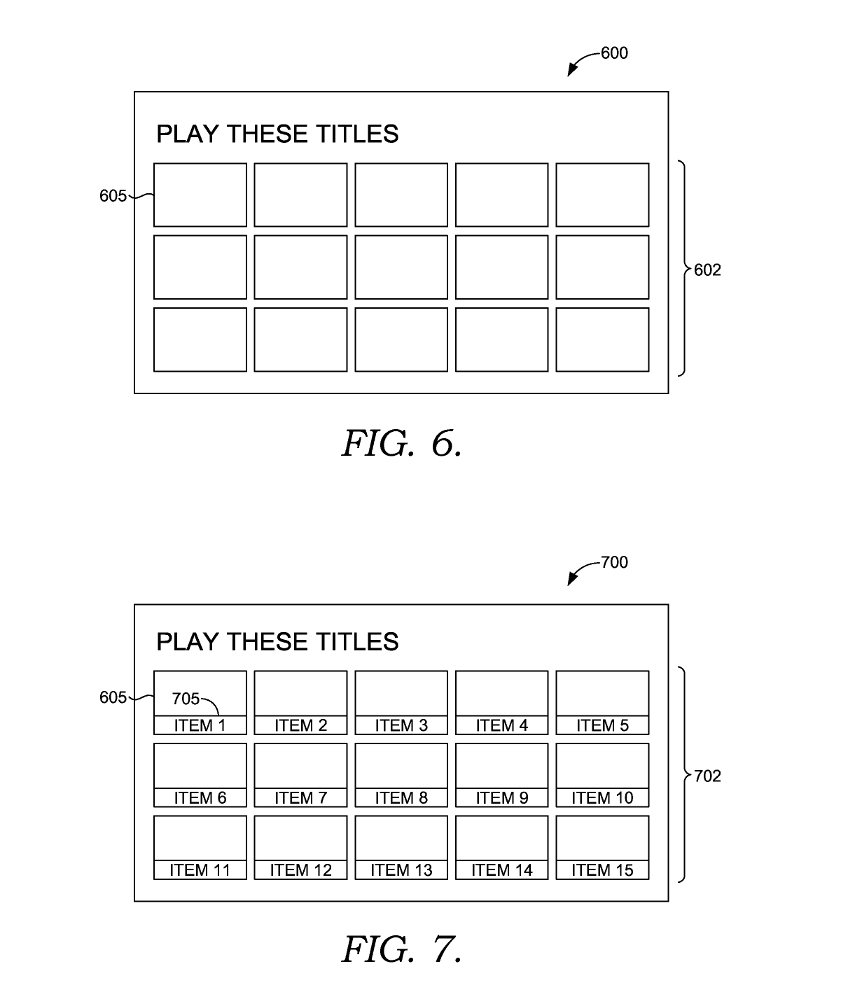

Turning now to FIG. 6 and FIG. 7, innumerable interactive elements are illustrated, in accordance with an embodiment of the present invention. Interface 600 includes a series of tiles 602 representing available content. Tile 605 is exemplary. Each tile may be selectable to start an application, play a movie, play a game, or take some other associated action. In one embodiment, the tiles each represent search results. The interface may specify that the elements within the interface are innumerable and are to be associated with a sequence of numbers for the purpose of voice phrases and interaction. The setting may be specific to the interface, rather than to each interactive element. For example, each element may be a search result selected from hundreds of thousands of possible elements that are generated using cover art, thumbnails, or other features. When each element is built on-the-fly, it may be associated with a number that becomes the voice phrase. The associated numbers and annotations are shown in FIG. 7.

Turning now to FIG. 7, the enumerated items 702 are shown listing items 1 through 15. Annotation 705 is exemplary and states “item 1.” The user would say “item 1” to select item 1. The voice phrase “item 1” will be registered with the phrase registry and associated with tile 605 within the element-to-phrase mapping record.

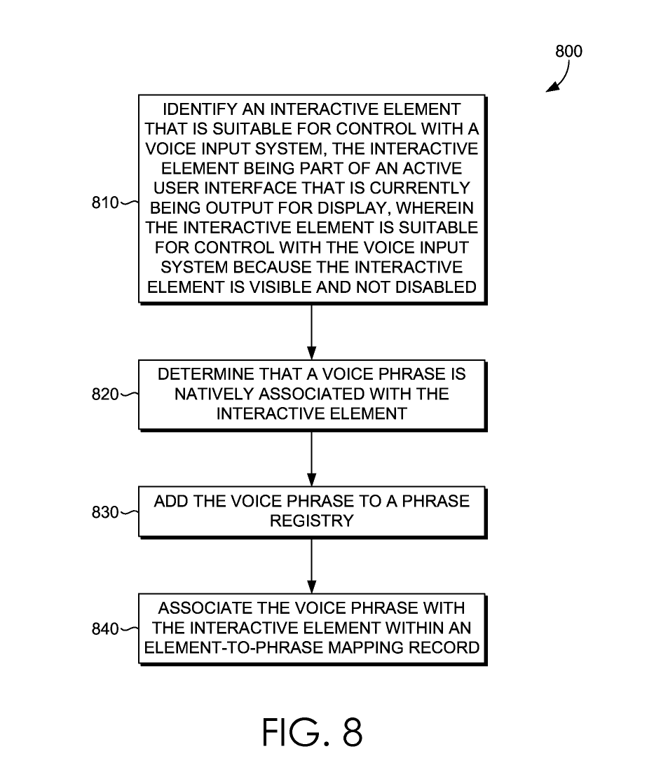

Turning now to FIG. 8, a method 800 automatically activating voice control input for an element within a user interface is provided, in accordance with an embodiment of the present invention. A step 810, an interactive element that is suitable for control with a voice input system is identified. The interactive element is part of an active user interface that is currently being output for display. The interactive element is suitable for control with the voice input system because the interactive element is visible and not disabled.

At step 820 a voice phrase that is natively associated with the interactive element is identified. At step 830, the voice phrase is added to a phrase registry. At step 840 the voice phrase is associated with the interactive element within an element-to-phrase mapping record.

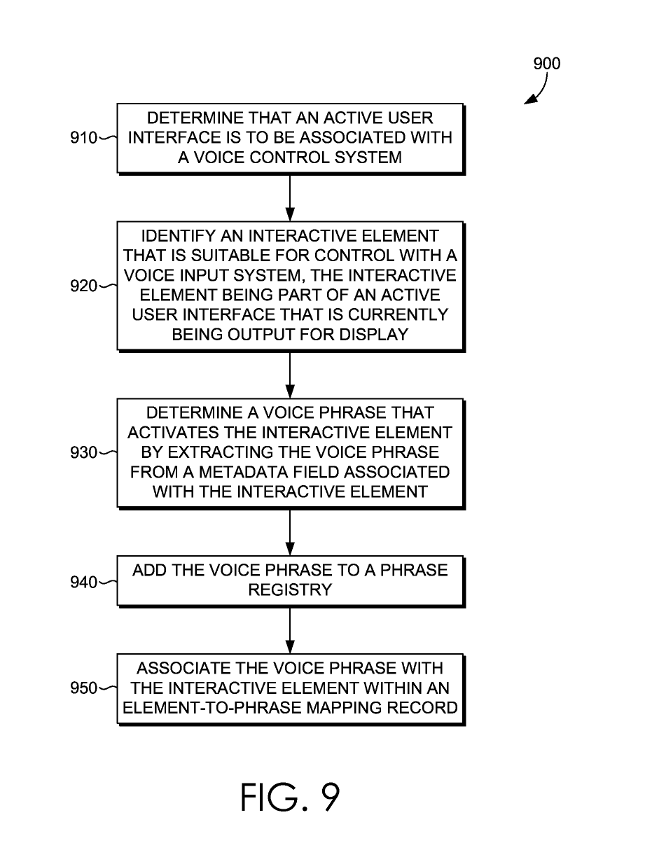

Turning now to FIG. 9, a method 900 automatically activating voice control input for an element within a user interface is provided, in accordance with an embodiment of the present invention. At step 910, it is determined that active user interface is to be associated with a voice control system. This determination may be in response to detecting a voice activation instruction. At step 920, an interactive element that is suitable for control with a voice input system is identified. The interactive element being part of an active user interface that is currently being output for display.

At step 930, a voice phrase that activates the interactive element is determined by extracting the voice phrase from a metadata field associated with the interactive element. At step 940, the voice phrase is added to a phrase registry. At step 950, the voice phrase is associated with the interactive element within an element-to-phrase mapping record.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-storage media having computer-executable instructions embodied thereon that when executed by a computing device perform a method of enabling a voice control system to control a user interface, the method comprising:
recognizing an active listening command by analyzing audio content comprising a user's voice speaking the active listening command;
identifying an interactive element that is suitable for control with a voice input system, the interactive element being part of an active user interface that is currently being output for display;
determining a voice phrase that activates the interactive element;
adding the voice phrase to a phrase registry;
associating the voice phrase with the interactive element within an element-to-phrase mapping record; and
changing the active user interface to include an annotation adjacent to the interactive element that indicates the voice phrase used to control the interactive element.

2. The media of claim 1, wherein the method further comprises recognizing the voice phrase by analyzing audio content received and, in response, calling a click-handler (broaden) on the interactive element.

3. The media of claim 1, wherein the method further comprises determining that active listening for the active user interface is complete and clearing the voice phrase registration and the voice phrase association from the voice control system's memory.

4. The media of claim 1, wherein said identifying the interactive element within the active user interface is accomplished by;
identifying a plurality of elements associated with the active user interface;
identifying and ignoring any of the plurality of elements that are off-screen elements;
identifying and ignoring any of the plurality of elements that are not focusable;
identifying and ignoring that any of the plurality of elements that are disabled; and
identifying and ignoring of the plurality of elements that are not visible.

5. The media of claim 1, wherein the interactive element is suitable for control with the voice input system because the interactive element is visible and not disabled.

6. The media of claim 1, wherein the voice phrase is a text content of the interactive element.

7. The media of claim 1, wherein the voice phrase is specified for the interactive element via a declarative markup.

8. The media of claim 1, wherein the method further comprises determining that the active user interface has changed and refreshing the element-to-phrase mapping record with a newly added interactive element that is suitable for voice input control.

9. A method of automatically activating voice control input for an element within a user interface, the method comprising:
identifying an interactive element that is suitable for control with a voice input system, the interactive element being part of an active user interface that is currently being output for display, wherein the interactive element is suitable for control with the voice input system because the interactive element is visible and not disabled;
determining that a voice phrase is natively associated with the interactive element;
adding the voice phrase to a phrase registry; and
associating the voice phrase with the interactive element within an element-to-phrase mapping record.

10. The method of claim 9, wherein the voice phrase is one of a plurality of voice phrases natively associated with the interactive element.

11. The method of claim 9, wherein the voice phrase is specified in a metadata field associated with the interactive element.

12. The method of claim 11, wherein the method further comprises determining a user interface framework used for the active user interface and determining the metadata field in which the voice phrase is specified within the user interface framework.

13. The method of claim 9, wherein the voice phrase is automatically generated using text from the interactive element.

14. The method of claim 9, wherein the method further comprises deleting entries in the phrase registry and the element-to-phrase mapping record when the active user interface changes.

15. One or more computer-storage media having computer-executable instructions embodied thereon that when executed by a computing device perform a method of automatically activating voice control a user interface, the method comprising:
determining that an active user interface is to be associated with a voice control system;
identifying an interactive element that is suitable for control with a voice input system, the interactive element being part of the active user interface that is currently being output for display;
determining a voice phrase that activates the interactive element by extracting the voice phrase from a metadata field associated with the interactive element;
adding the voice phrase to a phrase registry; and
associating the voice phrase with the interactive element within an element-to-phrase mapping record.

16. The media of claim 15, wherein the voice phrase is one of a plurality of voice phrases designated in the metadata field and wherein the method further comprises choosing the voice phrase from the plurality based on a contextual criteria.

17. The media of claim 16, wherein the contextual criteria is a language spoken by a user of the active user interface.

18. The media of claim 16, wherein the contextual criteria is speech patterns of a user of the active user interface.

19. The media of claim 16, wherein the interactive element is suitable for control with the voice input system because the interactive element is visible and not disabled.

20. The media of claim 15, wherein the method further comprises determining that the voice control system is done actively listening for voice phrases associated with the active user interface and releasing resources in the voice control system.
